(19) United States
(12) Patent Application Publication
(10) Pub. No.: US 2013/0304773 A1
(43) Pub. Date: Nov. 14, 2013

(54) METHOD AND SYSTEM FOR OPTIMIZING THE HANDLING OF APPLICATION FORMS

(71) Applicants: Kovendhan Ponnavaikko, Chennai (IN); Nischal M. Piratla, Hyderabad (IN)

(72) Inventors: Kovendhan Ponnavaikko, Chennai (IN); Nischal M. Piratla, Hyderabad (IN)

(73) Assignee: XEROX CORPORATION, Norwalk, CT (US)

(21) Appl. No.: 13/466,137

(22) Filed: May 8, 2012

(51) Int. Cl. G06F 17/30; G06F 15/16

(52) U.S. Cl. 707/825; 709/217; 707/E17.005

(57) ABSTRACT

The disclosure discloses a method and system for optimizing the handling of application forms. The method includes extracting annotated content from an application form. After this, at least one of: form type or form id related to the application form is determined. Then, the form id or form type is associated with the extracted content. Finally, the extracted content along with the form type or the form id is transmitted over the network for form reconstruction or other purposes.

### CROSS-REFERENCE TO RELATED APPLICATION(S)

The present application relates to U.S. application Ser. No. 13/359,510, filed Jan. 27, 2012, which is incorporated herein in its entirety by this reference.

### TECHNICAL FIELD

Broadly, the presently disclosed embodiments relate to application forms for various business services, more particularly, to methods and systems for optimizing data content of application forms.

### BACKGROUND

Business services, such as banking, telecom or postal play a significant role in the day-to-day life of individuals. To access any of the services, customers must fill out one or more application forms, which generally vary based on the service. For example, if the customer wishes to open a new account with a bank, she has to fill out an account opening form, but if the customer wants to apply for a loan, he or she has to fill out the corresponding loan application form. In the current scenarios, a customer fills out an application form in front of a branch representative and then the completed application form is transferred to a back-office. In the back-office, these forms are processed along with various other forms received from other branches and then stored for later retrieval. Thus, two of the most common processes related to application forms are: transferring and storing of forms.

In an application form that includes four pages, the completed form typically occupies 150 MB-200 MB per page. Transferring such amounts of data becomes challenging, especially, for remote areas, where broadband coverage is not good. Some remote areas depend on satellite links, but data losses and delay are the primary concerns. Therefore, network connectivity remains the challenging factor for remote areas.

As mentioned above, another common process is storing the forms for long periods. A single filled-out form requires around 600 MB of storage for one customer. This is just one example of form storage, and there are numerous forms, and other types of data maintained by the bank. Considering emerging markets, there are millions of bank customers, for example. Therefore, storing application forms for millions customers result into huge storage requirements, thereby, increasing the storage expenditure.

To summarize, network connectivity and storage requirements are the main limitations while handling application forms data and thus, there exist a need to overcome the limitations.

### SUMMARY

The present disclosure discloses a method for handling data content of application forms for transmission. The method includes extracting annotated content from an application form. After this, at least one of: form type or form id related to the application form is determined. Then, the form id or form type is associated with the extracted content. Finally, the extracted content along with the form type or the form id is transmitted over the network for form reconstruction or other purposes.

Other embodiments of the disclosure describe a method for handling data storage of application forms. The method includes extracting annotated content from an application form. The method further includes determining at least one of: form type or form id related to the application form. Furthermore, the method includes associating the at least one of: form type or form id with the extracted content. Finally, the method includes saving the extracted content along with the form type or the form id in a database.

Further, the disclosure proposes a system for handling data content of application forms. The system includes an extraction module configured for extracting annotated content from an application form. The system further includes a module, for example, identification module for determining at least one of: form type or form id related to the application form and associating the at least one of: form type or form id with the extracted content. Moreover, the system includes a network interface for transmitting the extracted content along with the form type or the form id over a network.

Moreover, the disclosure discloses a server for handling data content of application forms over a network. The server includes a module for receiving content from the network, the content including annotated content extracted from a filled-out application form and at least one of: a form id or a form type associated with the application form. The server further includes a re-construction module configured for determining an original application form based on the form id or the form type. After determining, the annotated content is embedded on the original application form to re-create the filled-out application form.

Additionally, the disclosure discloses a system for handling data content of application forms. The system includes an extraction module configured for extracting filled-out content from an application form. The system further includes an identification module configured for determining at least one of: form type or form id related to the application form, and associating the at least one of: form type or form id with the extracted content. Also, the system includes a database for saving the extracted content along with the form type or the form id.

Along with the above embodiments, the disclosure discloses a method for handling data content of application forms at a remote site. The method includes receiving content over a network, the content including filled-out content and at least one of: form id or form type. The method further includes determining an original application form, based on the form id or the form type. Finally, the method includes overlaying the filled-out content on the original application form to recreate the filled-out application form.

### BRIEF DESCRIPTION OF THE DRAWINGS

FIG. 1 illustrates an exemplary embodiment for optimizing the handling of application forms, according to the disclosure.

FIG. 2 is a flow chart for optimizing data transfer of application forms.

FIGS. 3A, 3B, and 3C are snapshots of an original application form, a filled-out form and extracted filled-out content, respectively.

FIG. 4 depicts a system for optimizing the handling of application forms.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### DEFINITIONS

In various embodiments of the present disclosure, definitions of one or more terms that will be used in the document are described below. The “processing system” is a device that includes various types of operations that are generally performed in a business center, such as bank branch, telecom center, postal office, or the like. In particular, the processing system performs the functionalities related to content of application forms, including, but not limited to, scanning, extraction, or compression. Also, the processing system is capable of receiving an input and may include a display feature for displaying an output. In addition, the processing system typically provides the functionality of scanning and may provide the functionalities of printing, faxing, and copying.

It is envisioned that the processing system can participate in a network with a number of other devices and entities. A “headquarters” device refers to a device at a higher organizational level than the processing system; “peer” devices are on the same general organizational level as the processing system; and “support systems” or “back-office” systems perform support and services operations, such as data entry, verifying documents, or processing transactions, or the like.

Overview

Broadly, the disclosure relates to handling application forms corresponding to various business services including banking, telecom, or postal services. For each of the business services, there are different application forms. For example, banking services have forms relating to opening a new account, changing personal information, applying for loan and so forth. While the application forms for telecom services include buying a new connection and so on. The primary aim of the present disclosure is to minimize the amount of data content related to application forms, while transmitting or storing the application forms over the network. More specifically, data handling optimization is performed both, at the customer end and the server end. At the customer end, a processing system is provided that allows a customer to scan a filled-out application form. Then, the content from the one or more fields filled-out by the customer are extracted and are sent to a back-office through the network. In the back-office, a server is provided to receive information from the processing system. The received data content may be stored for archiving or may be merged with an original blank application form to obtain the completed application form.

### Exemplary Embodiment

FIG. 1 illustrates an overall exemplary system of the disclosure. To analyze the present disclosure, FIG. 1 shows a processing system 102, a network 104, a server 106, and a database 108. Each of the shown components communicates with the others via conventional network protocols. Additionally, the server 106 and database 108 collectively, forms a part of a back-office. Each of these system components will be described in detail in the following sections. In one embodiment, the functionalities of database 108 may be integrated with the server 106 and thus, a single unit can be defined.

In this embodiment, the processing system 102 is a device performing all types of operations that are generally performed in a business center or bank branch, for example. In particular, the processing system 102 performs functions related to receiving filled-out application forms, scanning the forms, and optionally verifying the authenticity of the forms. Moreover, the processing system 102, in this embodiment, allows the user to perform additional activities including paying bills, viewing account summary, printing statements, printing reports, viewing branch reports, uploading documents, downloading documents, and so on, and may include printing and faxing functionalities, however these extraneous functions are not related to the system and method of the present disclosure. In one embodiment, the processing system 102 utilizes the functionality of scanning documents. The processing system 102 is capable of sending or receiving information to and from the network 104. The main purpose of the processing system 102 is to extract only the filled-out content from the application forms and sends it over the network 104. More details about the extraction and recombination process will be discussed below.

The network 104 is typically used to connect the processing system 102 to the back office, such as a central main bank branch. According to an embodiment of the present disclosure, network 104 may be wired or wireless. Network 104 includes all types of conventional wired or wireless network. Various examples of such networks include, but not limited to, Local Area Network (LAN), Wide Area Network (WAN), a Metropolitan Area Network (MAN), Wireless LAN, and so forth. Additionally, network 104 can be a local, regional, or global communication network such as an enterprise telecommunication network, the Internet, a global mobile communication network, or any combination of similar systems.

At the back-office, a server 106 receives the application form data from the processing system 102 and the received content is decompressed at the server 106 or processing center. The processing center reconstructs the completed forms for further processing.

In one example, the server 106 interacts with third party systems for validations. Moreover, the server 106, in this embodiment, stores the filled-out form data received from the processing system 102 in the database 108 as shown. The server 106 may also store a blank form associated with the data for subsequent reconstruction of the filled-out form, as discussed above. In one embodiment, a single blank form is stored together with multiple sets of data from multiple individuals that filled-out the same type of form.

Exemplary Flowchart

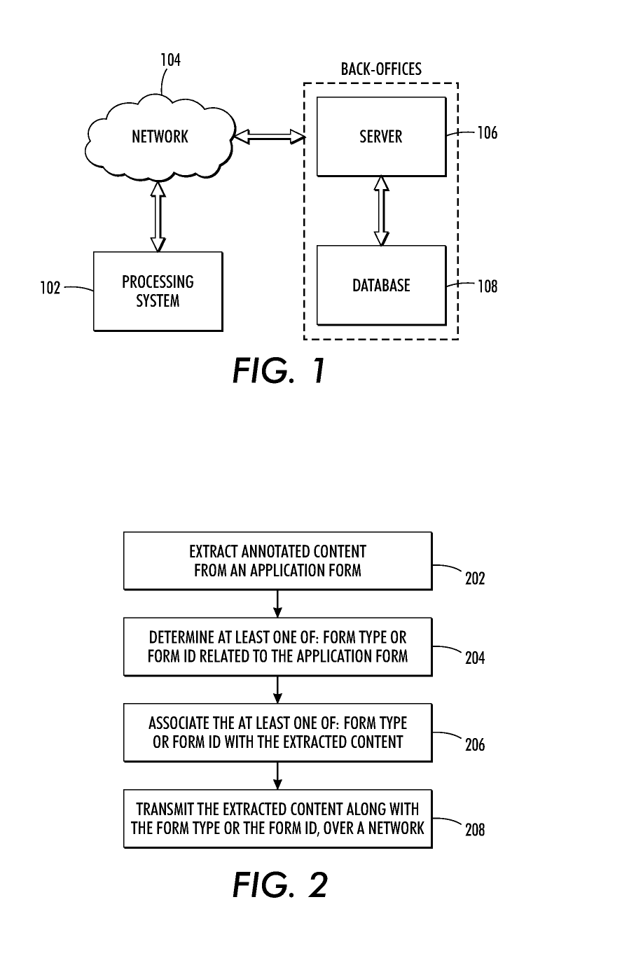

FIG. 2 is a flowchart for optimizing data content related to application forms.

Each time a user fills out an application form for a service, the completed form is scanned and the filled-out content is extracted. This content is then compressed using any compression algorithm known in the art, and sent to back-offices over the network. In the current solution, the content filled-out by the customer is sent without the background of forms, which are typically maintained at the back office. Since the application form itself remains unchanged and copies of the forms are typically maintained at the back office, the process of sending the filled-out content with background content or image is redundant. The blank application form, which defines the background data, includes a significant amount of data. Thus, it is a significant incursion on the bandwidth to send not only the filled-out content but also the form itself. Secondly, it requires a significant amount of space to store both the form and the filled-out content, thus, unnecessarily increasing the storage requirements. The present disclosure therefore solves this connectivity and storage issue by minimizing the amount of data content required for transmission and storage. This is achieved by sending or storing only the filled-out content over the network.

Before outlining the method flowchart, it must be noted that the optimization of data content of application forms is performed both, at the customer end and the server end. At the customer end, a processing system is provided; while at the back-office, a back-end server is maintained to handle the data content of the forms by saving the content and, if needed, recombining the data with a blank form to recreate a filled-out form.

At Processing System

To begin, a customer/user provides login details to access a processing system. Then, the user chooses an option of various options displayed. Based on the chosen option, the user is required to fill out one or more application forms having various fields such as first name, last name, age, date of birth, permanent address, or the like. The application forms can be filled-out through the processing system. Alternatively, and more typically in rural areas, the application forms are filled-out by hand after printing the form. In some scenarios, the customer may be required to fill-out additional forms such as signature change form, DA1 nomination form, tax forms, or internet banking form.

Once the application form is filled-out, the form is scanned by the processing system. In particular, the application form is scanned to convert the form data and filled-out data into digital format. The filled-out content is also called the annotated content. The filled-out content is then extracted as shown by step 202. As a result of the extraction, the background data defined by the original application form is separated from the filled-out content. Some examples of the extracted fields are photo, signature, name, age, and so on. To extract the fields, various existing match-lifting, annotation algorithms can be applied as known. Such algorithms extract the difference between the filled-out form and the original unfilled form. Sometimes, the user fills-out the content over the original form's content, thus, the filled-out content may be lost. In such scenarios, a broken stroke reconstruction algorithm may be applied to rebuild the lost content.

After extraction, at least one of: form type or the form id related to the application form is determined at step 204. Then, the form type or the form id is associated with the extracted or annotated content at step 206. The extracted content and the form type or form id are compressed using one or more predefined algorithms as known in the art. As a next step, the compressed fields/content are sent over a network, at step 208. Along with the compressed content, additional information, such as form type, form id, customer id, is transmitted. In some embodiments, the method includes saving the extracted content along with the form type or the form id in a database. Such information helps in identifying the particular form to be retrieved at the remote-site. Subsequently, the compressed content with the additional information is sent to back-offices for further processing. The compressed content is sent in the form of an image, for example.

At Back-Office

Back-offices typically include servers, databases, and systems for processing the application forms. Different back-end offices may include, a central, record-keeping office, processing centers for executing transactions, a third party validation system, or the like.

As mentioned above, the compressed content is received by the server in back-office and can be saved in this format in an efficient manner. The compressed content may also be decompressed using the same algorithms used for the compression. The decompressed content includes filled-out content and the form id, for example. In this embodiment, the server also recreates the original filled-out form by determining and retrieving the original application form using the form id from its database. The method also includes recreating the extracted content and its associated form type or the form id. Subsequently, the filled-out content is embedded over the blank application form. Thus, a completed application form is reconstructed at the server end. As a next step, the back-office considers the completed forms for any further processing. For example, the completed application form can be sent to third party for validations and so on.

Exemplary Application Forms

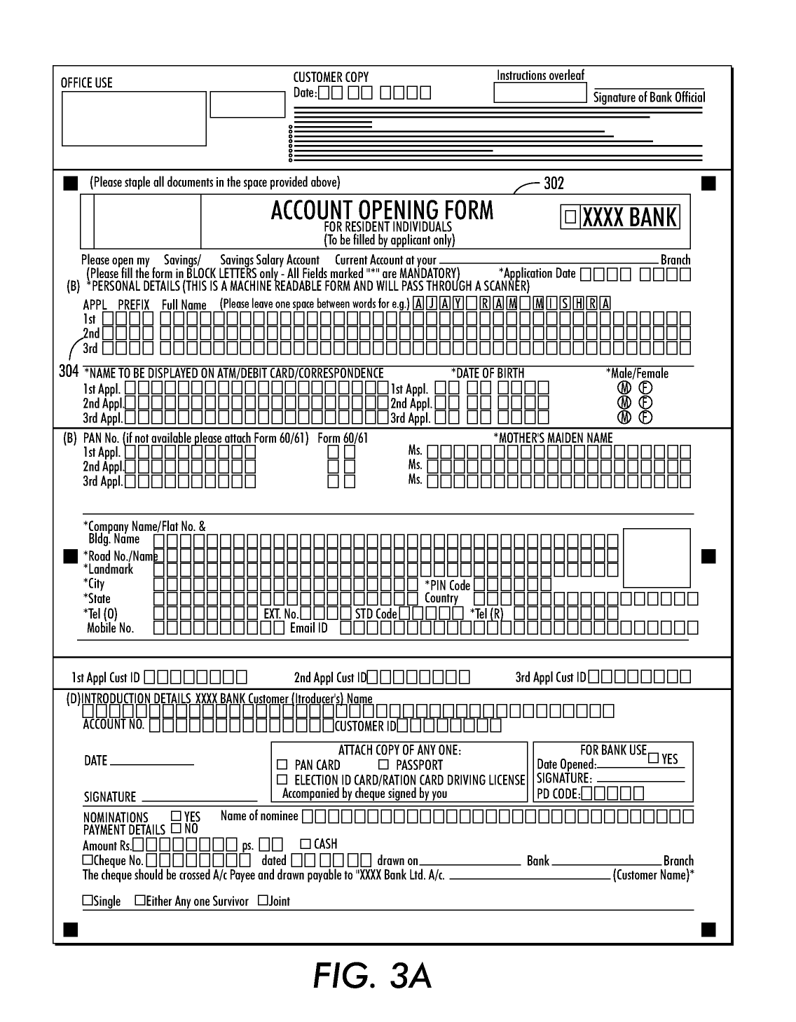

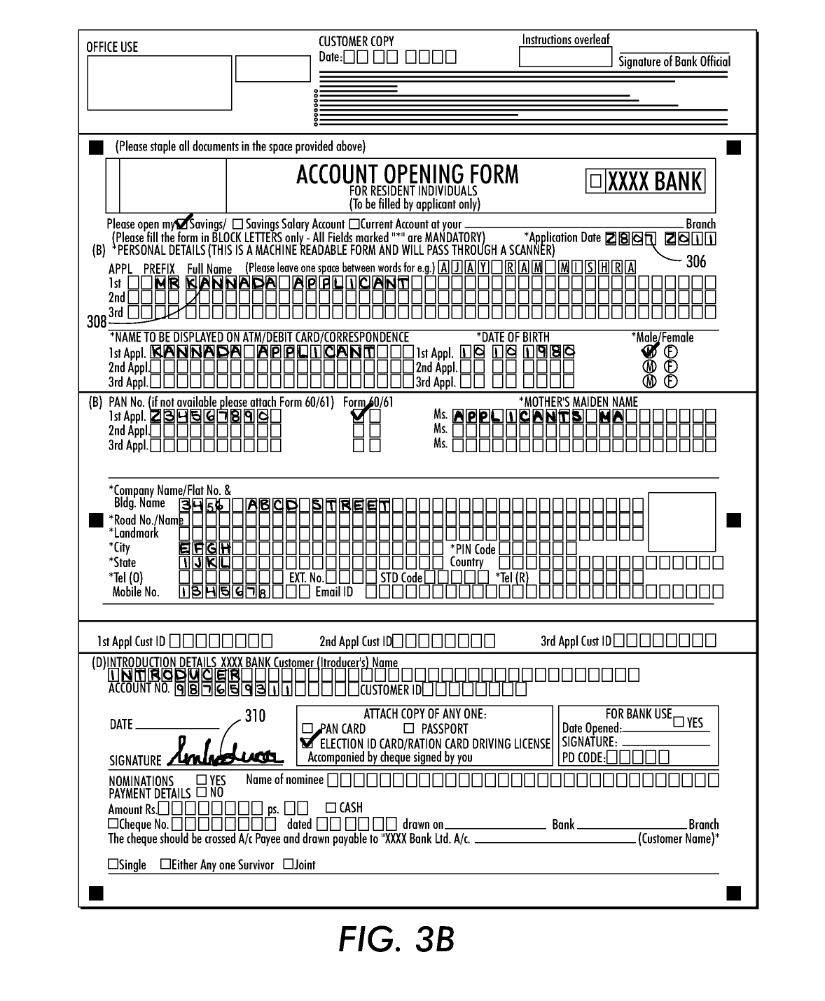

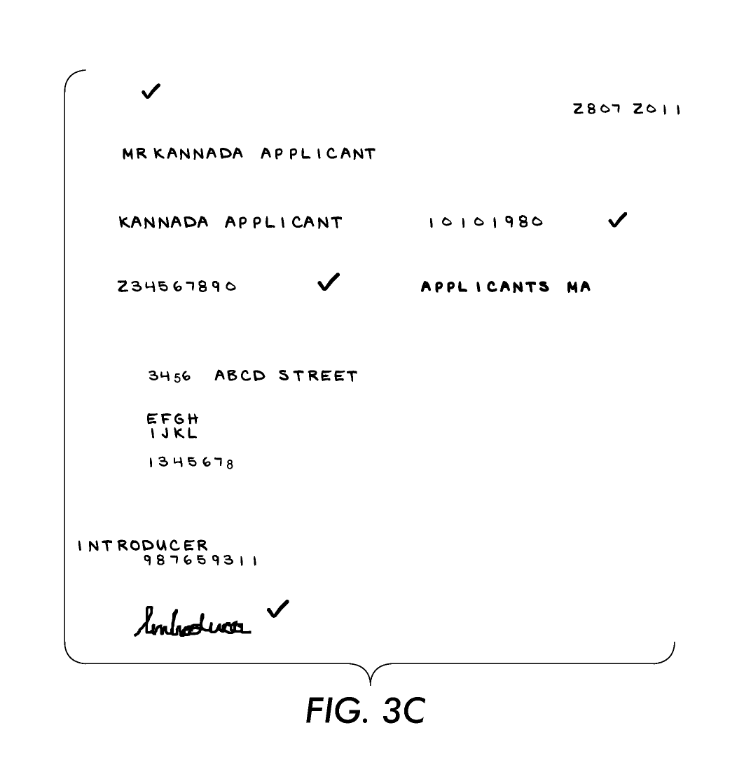

FIGS. 3A and 3B show an exemplary original application form and a filled-out application form, respectively. As shown, the original form 300 is blank and includes data marked as 302, and 304. This forms the background of the form and copies of these forms are stored in the back-office. FIG. 3B shows an application form filled-out by a user. The content filled by the user forms the filled-out content. As an example, the content filled-out by the user is shown as 306, 308, and 310. FIG. 3C shows the filled-out content extracted from the filled-out application form.

Exemplary System

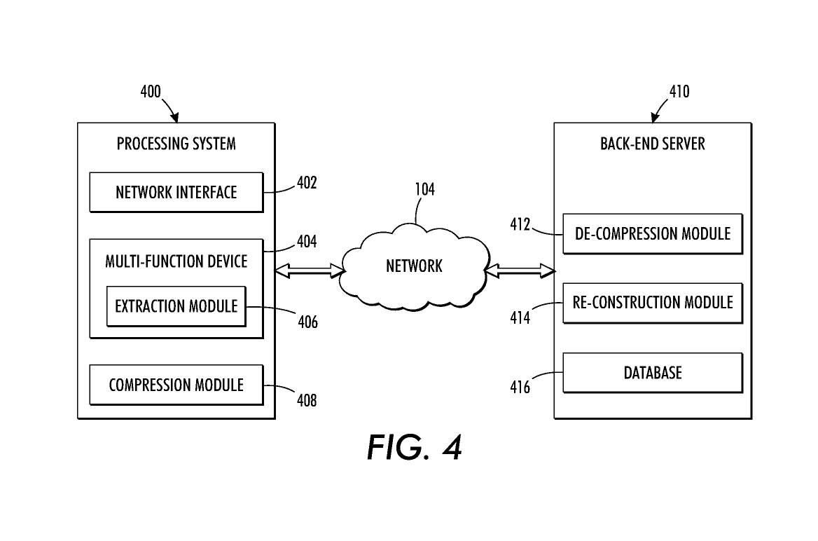

FIG. 4 discloses a system for optimizing data content of application forms. FIG. 4 includes a processing system 400, network 104, and a back-end server 410. The processing system 400 includes a network interface 402, a compression module 408, and a multi-function device 404, where the multi-function device 404 includes an extraction module 406. The processing system 400 also includes a user interface, although not shown. The back-end server 410 includes a de-compression module 412 a re-construction module 414, and a database 416.

The user interface displays one or more application forms for various business services. In the case of banking, application forms including opening a new account, or applying for loans are displayed. In telecom scenarios, forms such as buying a new connection and so forth are displayed. Based on the preferences, the customer in this embodiment chooses a form and fills out the form, on the processing system 400. Specifically, the customer needs to fill out various fields given on the application forms, such as first name, last name, age, residential address, contact number, and the like. Once the application form is filled-out successfully, the user interface interacts with the multi-function device 404 for further processing.

In this embodiment, the multi-function device 404 represents a single unit performing the functionalities of printing, scanning, copying or the like. Alternatively, the multi-function device 404 may be replaced by different units, such as printer, scanner, copier or the like. In cases where the user prints the application form and fills it out by hand, the multi-function device 404 is used to scan the filled-out application forms. The application form is processed to separate the background of the form from the content filled-out by the user. This is achieved by comparing the original application form with the filled-out application form. Then, the extraction module 406 extracts the fields filled-out by the customer. Examples of the extracted fields are name, age, signature, photo, and so on. Then a module, for example, an identification module (not shown) determines at least one of: form type or the form id related to the application and associate them with the extracted content. Then, the compression module 408 compresses the extracted fields along with the additional information such as form type, form id, or customer id, using the conventional compression algorithms. Additionally, the multi-function device 404 may be required to perform steps of realigning or enhancing the scanned information for clarity purposes. In cases where the user fills out the application form on the processing system 400, then the step of scanning the application form may not be required. In such implementations, only signature and photograph may be scanned.

Once the extraction and compression processes are completed, the processing system 400 sends the compressed content along with form id or the form type to the back-office for further processing. Additionally, the network interface 402 being configured for sending the compressed content over the network 104.

In the back-office, the compressed content is received by the back-end server 410 as shown. The compressed content may first be saved in a database 416 and subsequently retrieved for further processing or immediately be processed upon receipt by the back-end server 410. The further processing comprises a decompression and reconstruction of the filled-out form as discussed below.

The de-compression module 412 decompresses the compressed content using the known algorithms. The decompressed content includes annotated content and at least one of: form id or form type. As a next part, the re-construction module 414 first identifies the original application form based on the form id or form type and then embeds the annotated content on the original application form to re-create the filled-out application form. In some scenarios, the re-construction module 414 may perform steps of realigning or enhancing the form, for clarity purposes. For example, the re-construction module 414 enhances the quality of received content by skewing the information appropriately, varying the contrast, removing the noise and so forth. While embedding the decompressed content on the original form, the re-construction module 414 ensures that the content has same dimensions as shared by the processing system 400, number of bits/pixel, interleave compression, for example. In case of difference in dimensions, the re-construction module 414 performs the appropriate scaling as required. In this way, the filled-out application form is reproduced at the back-end server 410 and can be considered for any further steps.

The database 416 in this embodiment stores all types of application forms associated with each service. Each application form is associated with form type, form id or any other information that helps in identifying the forms. Additionally, the back-end server 410 stores only compressed content received from the processing system 400 in the database 416. The compressed content is stored for later retrieval or regulatory mandates.

The present disclosure discloses methods and systems for optimizing data content of application forms and has many advantages. The method helps in minimizing the amount of form data being sent over a network, thus, resolving bandwidth and connectivity issues. Moreover, the method reduces the amount of data that needs to be stored for archiving purposes.

1. A method for handling data content of application forms for transmission, the method comprising:
providing a single unit multifunction device having the functionalities of printing, scanning, and copying documents;
extracting annotated content from an application form in a module within the multifunction device;
determining at least one of: form type or form id related to the application form in a module within the multifunction device;
associating the at least one of: form type or form id with the extracted content in a module within the multifunction device; and
transmitting the extracted content along with the form type or the form id, over a network from a module within the multifunction device.

2. The method of claim 1, wherein the annotated content is the content filled-out by a user.

3. The method of claim 2 further comprising scanning the application form on the multifunction device with the annotated content filled-out by the user.

4. The method of claim 1 further comprising compressing the extracted content using one or more pre-defined algorithms in a module within the multifunction device.

5. The method of claim 1, wherein the extracting includes comparing an original application form with the application form filled-out by the user.

6. The method of claim 5 further comprising removing background data defined by the original application form from the filled-out application form.

7. A method for handling data storage of application forms, the method comprising:
scanning an application form on a multifunction device to produce digitized content from visible indicia on the form;
extracting annotated content from the form;
determining at least one of: form type or form id related to the application form in a module within the multifunction device;
associating the at least one of: form type or form id with the extracted content in a module within the multifunction device; and
saving the extracted content along with the form type or the form id in a database.

8. The method of claim 7 further comprising recreating a filled-out application form by retrieving the extracted content and its associated form type or form id, retrieving an original blank form corresponding to the form type or form id, and inserting the extracted content in the blank form.

9. The method of claim 7 further comprising compressing the extracted content before saving the extracted content in the database.

10. The method of claim 9 further comprising recreating a filled-out application form by retrieving extracted content and its associated form type or form id, decompressing the extracted content, retrieving an original blank form corresponding to the form type or form id, and inserting the extracted content in the blank form.

11. (canceled)

12. The method of claim 7 further comprising compressing the extracted content before saving it to the database.

13. The method of claim 7, wherein the extracting includes comparing an original application form with the application form filled-out by the user.

14. The method of claim 13 further comprising removing background data defined by the original application form from the filled-out application form.

15. The method of claim 7 further comprising reconstructing the filled-out form by merging the extracted content with a blank version of the original application form.

16. A system for handling data content of application forms, the system comprising:
a single unit multifunction device having office support functionality including, scanning, documents;
an extraction module within the multifunction device configured for extracting annotated content from an application form;
a module within the multifunction device configured for:
determining at least one of: form type or form id related to the application form;
associating the at least one of: form type or form id with the extracted content; and
a network interface for transmitting the extracted content along with the form type or the form id over a network.

17. The system of claim 16 further comprising a compression module configured for compressing the extracted content using one or more pre-defined algorithms.

18. The system of claim 16 further comprising a reconstruction module for merging the extracted content with a blank version of the original application form to reconstruct the filled-out form.

19.-22. (canceled)

23. A system for handling data content of application forms, the system comprising:
a single unit multifunction device having office support functionality including, scanning, documents
an extraction module configured for extracting filled-out content from an application form scanned on the multifunction device to produce digitized content from visible indicia on the form;
an identification module within the multifunction device configured for:
determining at least one of: form type or form id related to the application form, and
associating the at least one of: form type or form id with the extracted content; and
a database for saving the extracted content along with the form type or the form id.

24. The system of claim 23 further comprising a compression module configured for compressing the extracted content using one or more pre-defined algorithms.

25. The system of claim 23 further comprising a reconstruction module for merging the extracted content with a blank version of the original application form to reconstruct the filled-out form.

26.-28. (canceled)
